(19) United States
(12) Patent Application Publication
(10) Pub. No.: US 2012/0270123 A1
(43) Pub. Date: Oct. 25, 2012

(54) Fuel Cell Arrangement

(75) Inventors: Philipp Klose, Hamburg (DE); Alexander Franke, Hamburg (DE); Rolf Simon, Hamburg (DE)

(73) Assignee: BAXI INNOTECH GMBH, Hamburg (DE)

(21) Appl. No.: 13/505,682

(22) PCT Filed: Oct. 27, 2010
(86) PCT No.: PCT/EP2010/006556

§ 371 Date: Jul. 12, 2012

(30) Foreign Application Priority Data
Nov. 2, 2009 (DE) 10 2009 052 863.6

(51) Int. Cl. H01M 8/04; H01M 8/24; H01M 8/06

(52) U.S. Cl. 429/423

(57) ABSTRACT

The invention relates to fuel cell arrangement characterized in that the fuel cell stack is arranged in a fuel cell housing arranged within the main housing interior which is adapted to the shape of the fuel cell stack such that it encloses the fuel cell stack at a close distance, wherein the fuel cell housing comprises at least one intake opening connected to the interior of the main housing and at least one connection to the suction line connected to the intake side of the fan, and wherein a burner line connected to an inlet opening of the reformer burner is connected to the pressure side of the fan.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The invention relates to a fuel cell arrangement comprising a main housing having a main housing interior that is gas-tight with reference to the surroundings in which is located at least one reformer, a reformer burner supplying the reformer with thermal energy, and a fuel cell stack, wherein the main housing comprises at least one air connection, and wherein at least one fan is provided that draws air through the air connection into the interior of the main housing during operation.

Such fuel cell arrangements serve for example as fuel cell heaters. For reasons of safety, the external leakage from components in the arrangement must be controlled. In particular, a leakage gas that may exit such as hydrogen can form a combustible mixture with the air contained in the main housing which must be absolutely avoided. Consequently, it is known in the prior art to provide hydrogen sensors in the housing to identify a critical hydrogen leakage in a timely manner. This is complicated, however. It is also known to generate a vacuum in the housing by means of a fan in order to draw off leakage gas exiting from individual components. However, during this process dead spaces arise in the normally rectangular housings in which combustible gases can collect. EP 1 397 843 B9 therefore suggests adapting the shape of the housing of the fuel cell arrangement to the position of the components of the arrangement such that it encloses the components at a small distance. Dead spaces are to be avoided in this manner. The air flowing through the housing is supplied to the stack of fuel cells as processing gas. In addition, it is provided the air in the housing flows from cold to warm components of the fuel cell arrangement. This solution does in fact offer improved control of leakage. However, the structural design of the housing and arrangement of the components in the housing are substantially restricted.

### BRIEF SUMMARY OF THE INVENTION

Proceeding from the explained prior art, the object of the invention is to present a fuel cell arrangement of the initially-cited type that allows simple and reliable leakage control with significant flexibility in regard to the housing design and arrangement of the components in the housing.

For the fuel cell arrangement of the initially-cited type, the object is achieved by the invention in that the fuel cell stack is arranged in a fuel cell housing arranged within the main housing interior which is adapted to the shape of the fuel cell stack such that it encloses the fuel cell stack at a close distance, wherein the fuel cell housing comprises at least one intake opening connected to the main housing interior and at least one connection to the suction line connected to the intake side of the fan, and wherein a burner line connected to an inlet opening of the reformer burner is connected to the pressure side of the fan.

The fuel cell arrangement can be a fuel cell heater that is known per se. The main housing of the arrangement is sealed from the surroundings with the exception of one or more air connections. The surrounding air can be drawn into the main housing through the one or more air connections. Correspondingly, the one or more connections can, in a particularly simple matter, be only one opening to the surroundings of the main housing. The reformer serves to generate a hydrogen-rich gas of hydrocarbons in a manner known per se. For example, the reformer can obtain hydrogen from natural gas in a reforming process. The reforming process requires comparatively high temperatures. These are generated by the reformer burner. It performs a combustion process, and the arising heat is supplied to the reformer. A mixture of air and a combustion gas is burned in the combustion process. The air burned by the burner is the air that is drawn by the fan. The hydrogen-rich gas provided by the reformer is supplied as a first process gas to the stack of fuel cells. In addition, the fuel cell stack is supplied air as the second process gas. In particular, the air supplied as process gas to the fuel cell stack is not the air drawn by the fan through the air connection of the main housing. Instead, the air is advantageously supplied to the fuel cell stack from another source. The fan can also be arranged in the main housing.

According to the invention, the fuel cell stack is arranged in a separate fuel cell housing in the main housing. It is possible to arrange only the fuel cell stack in fuel cell housing. This separate housing tightly encloses the fuel cell stack. Only a narrow gap remains between housing wall and fuel cell stack. The gap can basically be between the entire outer surface of the fuel cell stack and the fuel cell housing, or only between one or more leakage-critical outer surfaces of the fuel cell stack and the fuel cell housing. Furthermore, a suction line is provided according to the invention that is connected on the one hand to the intake side of the fan, and on the other hand to a connection of the fuel cell housing. The fuel cell housing possesses at least one intake opening to the main housing. A plurality of intake openings can also be provided for a particularly even intake of air. Air is drawn from the main housing via at least one intake opening through the fuel cell housing and supplied via the suction line to the reformer burner. The fan generates a vacuum in the suction line that correspondingly also arises in the fuel cell housing and main housing. A volume of air therefore flows around the fuel cell stack. The reformer burner can cleanly burn the amount of leakage that may vary. The fan can in particular be the only device of the arrangement generating a vacuum and draw air only through the suction line. The entire air flow volume supplied to the reformer can originate from the main housing in that it enters via the one or more air connections of the main housing. It is guided between the outer surface(s) of the fuel cell stack and the corresponding inside(s) of the fuel cell housing. That the fuel cell stack is tightly enclosed by the fuel cell housing, or respectively that the distance between the fuel cell stack and walls of the fuel cell housing is slight, means in this context that there are basically no dead spaces between the stack and housing walls when air is drawn through the fuel cell housing. Instead, all of the gas leaving the fuel cell stack in the case of possible external leakage in the fuel cell housing, including from the area of the gas connections, is drawn off and supplied to the reformer burner via the intake line. External leakage from the fuel cell stack can therefore be reliably controlled. For example, a maximum distance of 10 cm, and preferably 5 cm, can be between the fuel cell housing walls and fuel cell stack.

The remaining components of the fuel cell arrangement, especially the reformer, reformer burner and possibly further components are in the main housing and do not need to have a separate housing. These further components can consequently to a large extent be distributed freely in the main housing, wherein the distances between the housing walls and these components can also be significantly larger than between the fuel cell stack and fuel cell housing. Dead spaces can correspondingly exist in the area of these distances when drawing air through the main housing. The invention is based on the knowledge that external leakage affects safety, especially in regard to the fuel cell stack. This is controlled according to the invention in a reliable manner without the structural restrictions of the prior art. For example, the arrangement of the fuel cell stack in the housing can be highly flexible. It does not have to be arranged in the path of the main flow of air through the main housing as in the prior art. The one or more air connections of the main housing and the remaining components of the fuel cell arrangement can to a large extent be distributed freely in the housing. The main housing can have a simple and practical shape, such as a rectangular shape. A defined flow path for the leakage gases is provided by supplying the air drawn through the fuel cell housing to the reformer burner via the suction line, which is gas tight in relation to a the surroundings, as well as the burner line. This ensures that any combustible leakage gases from the fuel cell stack cannot flow over potential sources of ignition in the main housing. In addition, release into the environment is prevented since the leakage gases are burned in the reformer burner.

According to one embodiment, it can be provided that at least one other component of the fuel cell arrangement is arranged in a separate housing within the main housing interior which is adapted to the shape of the components such that it encloses the component at a close distance, wherein the separate housing also has a connection to the intake line but is otherwise sealed gas tight from the main housing interior. The separate housing hence does not have a connection to the main housing interior except for the connection to the intake line connected via the fuel cell housing to the main housing interior. Air drawn by the fan therefore does not flow through the separate housing. The fan generates a vacuum in the intake line that entrains potential leakage gases, including in the separate housing, without a connection to the main housing interior in the suction line and to the reformer burner. Otherwise, the separate housing can be designed like the fuel cell housing.

The fuel cell arrangement can also have a sensor device that repeatedly records a measured quantity that characterizes the combustion quality of the reformer burner, and a control device that continuously compares the measured quantity to a setpoint and, in case of a deviation, controls the fan so that the measured quantity again assumes the setpoint. The combustion quality can be monitored in a manner known per se using a probe that, for example, measures the conductivity of the flame as a characteristic quantity of the combustion quality. An oxygen sensor, for example, is also conceivable that quantifies the percentage of oxygen in the air/gas mixture supplied to the reformer burner as a characterizing quantity for the combustion quality. If the measured values of the sensor device deviate impermissibly from a setpoint, for example by more than a specified threshold, the control device controls the fan output to change the combustion gas/air mixture until the measured values of the probe again correspond to the setpoint. Both the time and quantity of a gas leakage from the fuel cell stack are fundamentally unpredictable. The composition of the combustion air supplied to the reformer burner is correspondingly unpredictable. With this design of a pre-mixing burner, proper burning in the reformer burner is always possible, even when the gas quality fluctuates strongly. According to the invention, the amount of leakage can therefore be basically any level. If necessary, the control device can shut off the supply of a separate combustion gas to the reformer burner and switch the fuel cell heater to a safe state. For example, a higher level safety control system can monitor the control circuit and shut off the main gas valve for the fuel cell heater, if necessary.

According to another embodiment, at least one condensate trap can be arranged in the reformate line connected to the reformer to conduct reformate gas provided by the reformer, and can be connected via a condensate line to a drain line connected to the suction line for draining liquid condensate separated from the reformate gas flow flowing from the reformate line into a liquid reservoir. The reformate supplies reformate gas provided by the reformer to the fuel cell stack.

Critical components for (internal) leakage can be connected to the flow path defined by the suction line. Internal leakages are entrained to the reformer burner by the vacuum in the suction line. These critical components also include condensate traps that collect liquid condensate from the reformate line in a manner known per se. However, when there is leakage, the flow of condensate coming from the condensate trap can also contain leakage gases. These may then also enter the liquid reservoir. The liquid reservoir is normally open to the main housing interior. It therefore needs to be ensured that any leakage gases cannot pass through the condensate trap into the liquid reservoir and from there into the main housing interior where they may be able to form combustible mixtures. This is restricted by the embodiment of this invention. If leakage gases are also in the condensate flow from the condensate trap passing from the condensate line into the drain line, the gases are entrained into the suction line which reliably prevents the formation of a combustible mixture.

The drain line can have a greater cross-section than the suction line and/or the condensate line. The enlarged diameter represents a collection zone in which liquid condensate can separate from a leakage gas due to the slower space velocity.

The drain line can also have a slope up to 90% in the direction to the liquid reservoir such that the condensate inside drains under gravity while any leakage gases are entrained into the suction line. This ensures that condensate is not entrained into the suction line but rather drains into the liquid reservoir. The cross-section of the drain line can in particular be more than twice as large as the cross-section of the condensate line. In order to prevent perfusion through the drain line, a siphon can be arranged between the drain line and the liquid reservoir that separates the liquid reservoir gas tight from the suction line. The trap seal height of the siphon can be sufficiently high to prevent liquid from being drawn into the suction line even when the fan is at maximum output, and/or to prevent the condensate trap from being drained by the overpressure arising from maximum leakage. Maximum overpressure and underpressure therefore does not cause the siphon to drain or water to be fed to the fan. After being prepared, water from the liquid reservoir can be reused in the fuel cell heater process. In addition, the liquid reservoir can have an overflow so that liquid can drain from it.

### BRIEF DESCRIPTION OF THE SEVERAL VIEWS OF THE DRAWINGS

One exemplary embodiment of the invention is explained below in greater detail with reference to figures. The drawing shows schematically in:

FIG. 1 A vertical section of a fuel cell arrangement according to the invention, and

FIG. 2 A schematic portrayal of an enlarged section of the condensate trap provided in the arrangement in FIG. 1.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

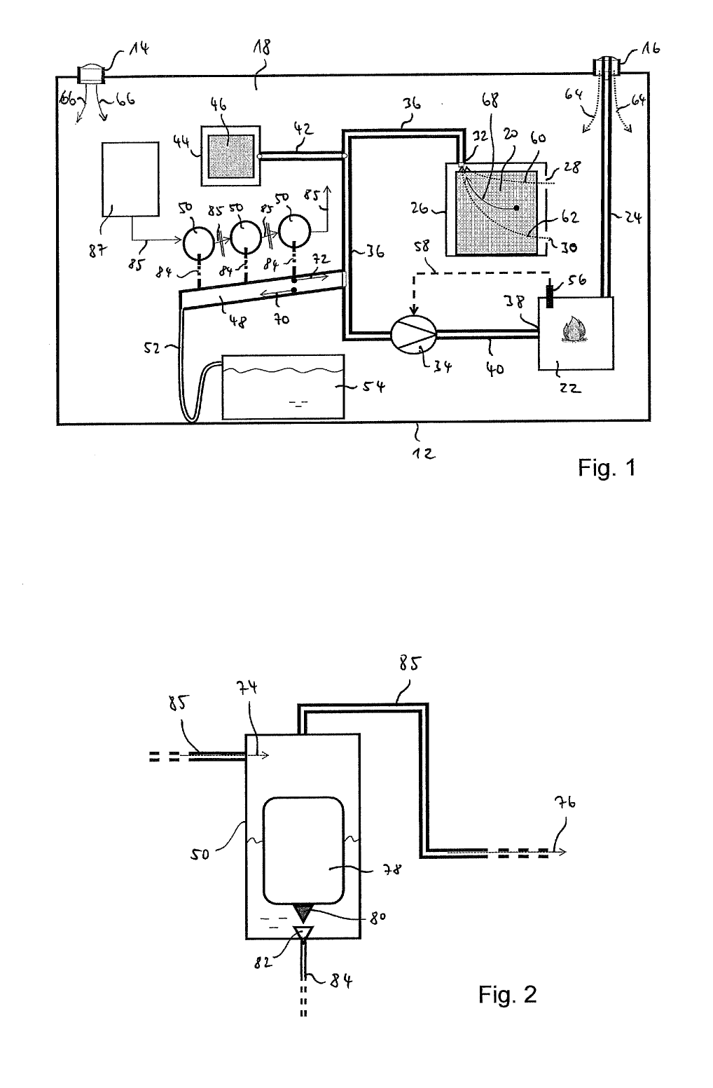

If not otherwise specified, the same reference numbers indicate the same objects in the figures. The fuel cell arrangement shown in FIG. 1 comprises a rectangular main housing 12 having a main housing interior 18 that is gas tight to the surroundings of the main housing 12 except for two air connections 14, 16. In the portrayed example, the air connections 14, 16 are provided in the top side of the main housing 12. The air connections can be provided alternatively or cumulatively. This is known per se. A plurality of components of the fuel cell arrangement are in the main housing 12, of which only a few are shown in FIG. 1 for reasons of clarity. This includes a fuel cell stack 20 and a reformer 87 that is also arranged in the main housing 12 and has a reformer burner 22 that supplies thermal energy. The reformer burner 22 has an exhaust line 24 leading from the main housing 12. It can be seen in FIG. 1 that the air connection 16 is designed as a pipe-in-pipe system, whereby the inner pipe is formed by the exhaust line 24, and the outer pipe forms an air inlet. The fuel cell stack 20 is thereby enclosed on all sides at a close distance, except for the bottom, by a separate fuel cell housing 26 arranged in the main housing 12. At the bottom, the fuel cell stack 20 is also enclosed by the fuel cell housing 26, but not at a distance. In the portrayed example, the fuel cell housing 26 possesses two intake openings 28, 30 that are connected to the main housing interior 18. Of course, more than two intake openings can be provided, or naturally only one intake opening. In addition, the fuel cell housing 26 possesses one connection 32 to a suction line 36 connected to the intake side of the fan 34. A burner line 40 is connected to the pressure side of the fan 34 that is connected to an inlet opening 38 of the reformer burner 22. Furthermore, another separate housing 44 is arranged in the main housing interior 18 via a line 42 branching from the suction line 36 in the top area of the portrayed example. In the housing 44, there is any number of additional component 46 of the fuel cell arrangement that can leak gas while operating. The shape of both the separate housing 44 and fuel cell housing 26 is adapted to the components 46 or fuel cell stack 20 therein such that they enclose the components 46 or respectively fuel cell stack of 20 at a close distance. The fuel cells 20 are supplied on the one hand with the hydrogen-rich gas provided by the reformer and, on the other hand, air such as the surrounding air via lines (not shown) for operation.

It can also be seen that a drain line 48 is connected to the suction line 36 between the fan 34 and branching line 42. Three highly schematic condensate traps 50 are each connected to the drain line 48 in the portrayed example via one condensate line 84. The condensate traps 50 are arranged in a reformate line 85 of a reformer 87 that is also arranged in the main housing 12. At its end facing away from the suction line 36, the drain line 48 ends in a siphon 52 that in turn is connected to a liquid reservoir 54. The drain line 48 slopes downward toward the siphon. Finally, the reformer burner 22 is assigned a sensor device 56 that continuously measures a characteristic quantity for the combustion quality of the burner 22. The combustion quality provides information about the air/combustion gas mixture supplied to the burner 22. The burner 22 is therefore supplied with air possibly enriched with leakage gas via the suction line 36 and burner line 40 in a manner that will be further explained. In addition, a combustion gas is supplied to the burner 22 via a line (not shown). The combustion gas can for example also be supplied before the burner air fan. The air/combustion gas mixture is burned in the reformer burner 22. The measured values from the sensor device 56 are sent to a control device (not shown) that can control the output of the fan 34 as indicated by the arrow 58 in FIG. 1. This will be further explained below.

The device works as follows: While operating, the fan 34 generates a vacuum in the suction line 36 and hence also in the gap between the fuel cell housing 26 encasing the fuel cell stack 20. This vacuum ensures that air from the main housing interior 18 flows through the intake openings 28, 30 past the fuel cell stack 20 and through the connection 32 into the suction line 36. This is illustrated in FIG. 1 by the arrows 60, 62. The vacuum also arises in the main housing interior 18 such that surrounding air flows through the air connections 14, 16 into the main housing interior 18 as illustrated in FIG. 1 by the arrows 64, 66. The small distance between the walls of the fuel cell housing 26 and fuel cell stack prevents dead spaces from arising. Instead, air flows over all of the surfaces of the fuel cell stack 20 at a distance from the walls of the fuel cell housing 26. When the air is flowing over the fuel cell stack 20, all of the leakage gases possibly exiting therefrom, including leakage gases from the area of the connections, are entrained into the suction line 36 as illustrated in FIG. 1 by the arrow 68. The air which may be enriched with leakage gases flows through the suction line 36 to the intake side of the fan 34 and from its pressure side through the burner line 40 to the inlet opening 38 of the reformer burner 22 where, if applicable, it is burned together with a combustion gas. The vacuum in the suction line 36 spreads into the line 42 branching therefrom such that a vacuum also arises between the other component 46 and the separate housing 44 and, as the case may be, entrains the leakage gases arising from these components 46. Furthermore, the small distance between the walls of the housing 44 and the component 46 prevents dead spaces from arising. Any available liquid condensate is separated by the condensate traps 50 from the gas flowing through the reformate line 85. This flows via the condensate lines 84 into the drain line 48 and from there through the siphon 52 into the liquid reservoir 54 as illustrated by the arrow 70 in FIG. 1. Any leakage gases that may arise in the condensate traps 50 are contrastingly drawn off by the vacuum arising from the suction line 36 as indicated by the arrow 72. The siphon 52 has a sufficient high trap seal height to prevent condensate from being drawn into the suction line 36, even under maximum fan output. The construction of the drain line 48 and siphon is designed for example with a sufficient height such that no water can enter the suction line 36 from the siphon 52 via the drain line 48, even when the fan 34 is operated at its maximum. The sensor device 56 and associated control device ensure that the reformer burner 22 always receives a proper air/combustion gas mixture for combustion. Of course, other components can be arranged in the main housing beside the components shown in FIG. 1.

FIG. 2 shows a schematic enlargement of additional details of an example of a condensate trap 50 from FIG. 1. The condensate trap 50 arranged in the combustion gas path is supplied liquid condensate such as water containing combustion gas as illustrated by the arrow 74. The gas is separated from the liquid in the trap 50. Via the reformate line 85, the combustion gas separated from the liquid flows out of the condensate trap 50 as indicated by the arrow 76. The condensate trap 50 has a float 78 that rises or falls depending on the level of the liquid. On its bottom side, the float 78 has a sealing body 80 that, when inserted into a corresponding sealing seat 82 at the foot of the condensate trap 50, either releases or closes a connection to the condensate line 84. In the example shown in FIG. 2, the level of liquid in the condensate trap 50 has reached a level where the float 78 and the sealing body 80 with it have been removed from the sealing seat 82, thus allowing the liquid to flow through the condensate line 84 to a given height, whereupon the sealing body 80 of the float 78 lowers back into the sealing seat 82. The liquid level in the condensate trap 50 can be kept constant within a band in this manner. By means of the drain line 48 and the siphon 52 (not shown in FIG. 2 for reasons of clarity), the separated liquid portion flows into the reservoir 54.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A fuel cell arrangement comprising a main housing (12) having a main housing interior (18) that is gas-tight with reference to the surroundings in which is located at least one reformer, a reformer burner (22) supplying the reformer with thermal energy, and a fuel cell stack (20), wherein the main housing (12) comprises at least one air connection (14, 16), and wherein at least one fan (34) is provided that draws air through the air connection (14, 16) into the main housing interior (18) during operation, characterized in that the fuel cell stack (20) is arranged in a fuel cell housing (26) arranged within the main housing interior (18) which is adapted to the shape of the fuel cell stack (20) such that it encloses the fuel cell stack (20) at a close distance, wherein the fuel cell housing (26) comprises at least one intake opening (28, 30) connected to the main housing interior (18) and at least one connection (32) to the suction line (36) connected to the intake side of the fan (34), and wherein a burner line (40) connected to an inlet opening (38) of the reformer burner (22) is connected to the pressure side of the fan (34).

2. The fuel cell arrangement according to claim 1, characterized in that at least one other component (46) of the fuel cell arrangement can be arranged in a separate housing (44) within the main housing interior (18) which is adapted to the shape of the components (46) such that it encloses the component (46) at a close distance, wherein the separate housing (44) also has a connection to the intake line (36) but is otherwise sealed gas tight from the main housing interior (18).

3. The fuel cell arrangement according to claim 1, further characterized by a sensor device (56) that repeatedly records a measured quantity that characterizes the combustion quality of the reformer burner (22), and a control device (58) that continuously compares the measured quantity to a setpoint and, in case of a deviation, controls the fan (34) so that the measured quantity again assumes the setpoint.

4. The fuel cell arrangement according to claim 1, characterized in that at least one condensate trap (50) is arranged in the reformate line connected to the reformer to conduct reformate gas provided by the reformer, and can be connected via a condensate line (84) to a drain line (48) connected to the suction line (36) for draining liquid condensate separated from the reformate gas flow flowing from the reformate line into a liquid reservoir (54).

5. The fuel cell arrangement according to claim 4, characterized in that the drain line (48) has a larger cross-section than the suction line (36) and/or the condensate line (84).

6. The fuel cell arrangement according to claim 4, characterized in that the drain line (48) is connected to a siphon (52) the trap seal height of which is sufficiently high to prevent liquid from being drawn into the suction line (36) even when the fan (34) it is at maximum output, and/or to prevent the condensate trap from being drained by the overpressure arising from maximum leakage.

7. The fuel cell arrangement according to claim 4, characterized in that the liquid reservoir (54) has an overflow so that liquid can drain from it.
